(19) United States
(12) Patent Application Publication
(10) Pub. No.: US 2025/0196159 A1
(43) Pub. Date: Jun. 19, 2025

(54) AIR FILTER UNIT

(71) Applicant: MAHLE International GmbH, Stuttgart (DE)

(72) Inventors: Markus Steppe, Renningen (DE); Steffen Gukelberger, Marbach am Neckar (DE); Matthias Herb, Ebersbach (DE); Birgit Renz, Marbach (DE); Andre Bogenschuetz, Bissingen (DE); Daniel Eberle, Ludwigsburg (DE); Markus Michael, Ilsfeld (DE); Florian Klein, Bad Liebenzell (DE)

(21) Appl. No.: 18/985,010

(22) Filed: Dec. 17, 2024

(30) Foreign Application Priority Data
Dec. 18, 2023 (DE) 10 2023 135 631.3
Nov. 25, 2024 (DE) 10 2024 134 663.9

(51) Int. Cl. B03C 3/16; B01D 46/00; B01D 46/52; B01D 46/54; B01D 53/04; B03C 3/38; B03C 3/47; B60H 3/00

(52) U.S. Cl. CPC B03C 3/16; B01D 46/0032; B01D 46/0036; B01D 46/521; B01D 46/546; B01D 53/04; B03C 3/38; B03C 3/47; B60H 3/0071; B01D 2253/102; B01D 2253/206; B01D 2258/06; B01D 2259/4566; B01D 2275/10; B01D 2279/40; B03C 2201/30

(57) ABSTRACT

An air filter unit may include at least one ionization unit and at least one filter medium arranged downstream of the ionization unit. The ionization unit may include at least one corona discharge electrode, at least one counter-electrode, and at least one voltage source. The at least one filter medium may include at least one electret layer, at least one mechanically separating layer, and at least one electrically conductive layer adjoining the mechanically separating layer. In an airflow direction extending from an inflow side toward an outflow side, the electret layer, the mechanically separating layer, and the electrically conductive layer may be arranged one after another in this order.

### CROSS-REFERENCE TO RELATED APPLICATIONS

This application claims priority to German Patent Application No. DE 10 2024 134 663.9, filed on Nov. 25, 2024, and German Patent Application No. DE 10 2023 135 631.3, filed on Dec. 18, 2023, the contents of both of which are hereby incorporated by reference in their entirety.

### TECHNICAL FIELD

The present invention relates to an air filter unit, in particular for a motor vehicle. The invention also relates to the use of such an air filter unit in a motor vehicle.

### BACKGROUND

To achieve a high and pleasant air quality in the passenger compartment of a motor vehicle, the fresh air supplied from outside must be cleaned of particles, such as fine dust particles, and harmful gases, such as volatile hydrocarbons, nitrogen oxides, ammonia, ozone, or hydrogen sulfide. Particularly in urban areas, high levels of particulate matter are often found in the outside air. For example, the daily average particulate matter pollution in large cities can often exceed the WHO's prescribed PM2.5 daily average of 15 μg/m3. This can pose a massive health risk.

In the prior art, dusts that would otherwise enter the passenger compartment via the air conditioning unit, for example, are often separated by means of a filter element that is installed in the air conditioning unit, for example, and has a fibrous filter layer for separating particles. However, the space available in such air conditioners is limited. At the same time, minimum safety requirements, for example to prevent windows from fogging up, must be met, which requires an adequate air supply. To ensure adequate airflow, the filter element must have a low flow resistance and a low pressure drop. The disadvantage of this is that the layer of particle-separating filter fibers typically has to be very porous. As a result, the mechanical dust separation efficiency is often very low.

To get around this problem, filter media that attract electrostatically charged particles are often proposed in the prior art. For this purpose, filter media are electrostatically charged during the production process, for example, or filter media are used that already have a certain electrostatic charge even without special charging processes during the production process. This means that the dust particles, which are often also electrostatically charged, even very small particles with a diameter of <0.3 μm, can initially be easily separated during operation with the electrostatically charged filter medium. This also means that the flow resistance of the filter does not have to be increased. For example, EP3056364A1 describes the use of a dielectric material, such as polypropylene, as a filter medium.

However, an electrostatic charge applied during the production process, for example, quickly decreases with the aging of the filter medium and the increasing dust exposure during operation. This means that the electrostatic attraction of the filter medium is only effective at the beginning of the filter's life cycle, and, depending on the level of outdoor air pollution, often after only a few weeks or months, there is a significant decline in the electrostatic attraction. This means that the occupants of the vehicle are exposed to a significantly increased particle concentration well before the filter medium change interval.

### SUMMARY

The present invention addresses the problem of providing a filter system for cleaning the outside air fed into the passenger compartment, with which a sufficient filtration effect can be achieved even with a high airflow and over longer periods of use.

According to the invention, this problem is solved by the subject matter of the independent claim(s). Advantageous embodiments are the subject matter of the dependent claim(s).

According to the invention, it is intended to equip an air filter unit with at least one ionization unit and at least one filter medium, wherein the at least one ionization unit has at least one corona discharge electrode, at least one counter-electrode, and at least one voltage source, and wherein the at least one filter medium is located downstream of the ionization unit, and viewed from an inflow side in the direction of the outflow side, first has at least one electret layer, then at least one mechanically separating layer, and adjoining this, at least one electrically conductive layer.

The air filter unit according to the invention with the features of independent claim 1 has the significant advantage over the prior art that a high particle separation efficiency is achieved over the entire lifetime of the filter medium. This is partly due to the fact that the electrostatic separation effect of the air filter unit can be maintained during the lifetime of the filter medium.

Another major advantage of this is that the air filter unit provides a good level of separation efficiency with a low pressure drop throughout the entire service life of the filter medium, which means that the vehicle occupants are exposed to a significantly lower particle load. At the same time, the flow resistance of the system is comparable to that of conventional cabin air filters, which have a significantly lower particle separation efficiency.

This is achieved in particular by the proposed combination of the at least one ionization unit and the at least one filter medium, wherein the at least one filter medium, when viewed from an inflow side in the direction of the outflow side, first has at least one electret layer, then at least one mechanically separating layer, and adjoining this, at least one electrically conductive layer.

The air filter unit according to the invention is explained in more detail below.

The present invention is based on the general idea of designing at least one filter medium for cleaning the air conducted from the outside into the passenger compartment and combining it with at least one ionization unit in such a way that the supplied air can be effectively cleaned.

Accordingly, an air filter unit, for example for a vehicle air conditioning unit, a vehicle ventilation system, a vehicle heating system or a combined heating, ventilation and air conditioning (HVAC) system, is proposed, through which an airflow passes. The airflow is an airflow that is used to conduct air from the outside into the interior of the vehicle, in particular into the passenger compartment. Consequently, the inflow side is understood to be the side from which the airflow is supplied from outside. The air filter unit has at least one ionization unit arranged in the flow path and at least one filter medium arranged in the flow path downstream of the ionization unit.

This means that the air filter unit can have an ionization unit arranged in the flow path and a filter medium arranged in the flow path downstream of the ionization unit. Alternatively, however, it is also conceivable that the air filter unit has two or more ionization units arranged in the flow path and two or more filter media arranged in the flow path downstream of the respective ionization unit. It has proven to be particularly advantageous when the air filter unit has an ionization unit arranged in the flow path and a filter medium arranged in the flow path downstream of the ionization unit.

The purpose of the at least one ionization unit is to ionize at least some of the particles contained in the externally supplied air. In principle, all suitable ionization units known to the person skilled in the art are conceivable. For example, ionization units are described in US2021/0021107A1 and EP3056364A1.

The at least one ionization unit has at least one counter-electrode. It is conceivable, for example, that there is initially at least one counter-electrode in the air path on the inflow side. The at least one counter-electrode can, for example, be designed as a grid structure made of an electrically conductive material, which is located in the air path and allows air to flow through it. For example, such a lattice structure may contain steel, in particular stainless steel. Furthermore, the at least one ionization unit has at least one corona discharge electrode. This means that the ionization unit has one or more corona discharge electrodes. It goes without saying that the at least one counter-electrode is electrically isolated from one or more of the corona discharge electrodes. The one or more corona discharge electrodes can be located at different positions in the flow path, for example, they are located downstream of the at least one counter-electrode in the flow path and can be designed, for example, as electrode rods.

It has also proven to be advantageous if the at least one counter-electrode located on the inflow side in the air path is arranged at a distance of at least about 15 mm to a maximum of about 50 mm from the or each corona discharge electrode. In addition, the ionization unit has a voltage source, in particular a high-voltage source, to which the at least one counter-electrode and the one or more corona discharge electrodes are connected in an electrically conductive manner.

For example, an electric field is generated between one or more corona discharge electrodes and at least one counter-electrode in the flow path. It is useful if a first electrical potential is or can be applied to the air filter unit at one or more of the corona discharge electrodes and a second electrical potential, which is different from the first electrical potential, is or can be applied to the at least one counter-electrode. For example, it is conceivable that the first electrical potential is a supply potential and the second electrical potential is a counter-potential. For example, a counter-potential can be obtained by connecting the at least one counter-electrode to ground. For example, the counter-potential may be a zero potential. It is useful if a negative or positive potential difference is or can be applied in the operation of the air filter unit between the at least one counter-electrode and the one or more corona discharge electrodes. For example, a negative potential difference in the range of approximately a minimum of −5 kV to approximately a maximum of −15 kV can be applied. In this case, a negative corona discharge is possible at one or more of the corona discharge electrodes.

With the help of one or more corona discharge electrodes, a negative or positive corona discharge can be generated and gas molecules can be ionized from the air. In principle, it is possible to generate a direct, alternating or impulse corona discharge using the ionization unit. In principle, an electrical potential with negative polarity or an electrical potential with positive polarity can be applied to the corona discharge electrode or corona discharge electrodes. It has been shown to be particularly advantageous when a DC voltage with negative polarity is applied to the corona discharge at the corona discharge electrode or corona discharge electrodes. This produces more ions than positive polarity. The ionized gas molecules that are obtained can attach themselves to the surface of the particles contained in the externally supplied air, causing the particles to become electrically charged.

It is also conceivable that one or more additional counter-electrodes are arranged downstream of the corona discharge electrodes. For example, such a further counter-electrode can be electrically conductively connected to an electrically conductive, flat filter layer of the at least one filter medium, in particular to the at least one electrically conductive layer. This will be discussed in more detail later.

After the ionization of the airflow in the at least one ionization unit, the ionized airflow strikes the at least one filter medium. It goes without saying that in this context, an ionized airflow refers to nothing more than an electrostatic charge of at least some of the gas molecules of the air in the airflow, as well as at least some of the particles carried in the airflow. For example, it is conceivable that the at least one filter medium is arranged at a distance of approximately a minimum of 1 mm to approximately a maximum of 50 mm, preferably at a distance of approximately a minimum of 5 mm to approximately a maximum of 20 mm, from the at least one ionization unit.

The filter medium, of which there is at least one in the invention, has at least one electret layer on the inflow side. In this context, “on the inflow side” means that the airflow supplied from the outside, which was initially ionized by the ionization unit, then initially hits the electret layer of the filter medium. An electret is an electrically insulating material which contains quasi-permanently stored electrical charges or quasi-permanently aligned electrical dipoles and thus generates a quasi-permanent electrical field in its environment or inside itself. Electret layers can be made, for example, from polymer fibers such as polypropylene or polyethylene terephthalate fibers. The at least one electret layer has an electrostatic charge. The particle separation at the at least one electret layer is thus mainly based on an electrostatic separation effect. One function of the at least one electret layer is to collect larger dust particles.

At least one mechanically separating layer is arranged on the outflow side of the at least one electret layer. It is understood that the downstream side of the at least one electret layer is understood in this context to mean that the externally supplied ionized airflow first strikes the electret layer, where at least some of the electrostatically charged particles are deposited and the airflow, without these already deposited particles, exits on the opposite side of the electret layer and strikes the at least one mechanically separating layer there. The at least one mechanically separating layer is protected by the at least one electret layer in front of it, in that a large proportion of the larger particles are trapped in the at least one electret layer, which means that clogging of the at least one mechanically separating layer and an associated increase in flow resistance can be largely avoided or at least greatly delayed. The at least one mechanically separating layer can, for example, be a nonwoven made of nanofibers, whereby the separation effect is based on the fact that the at least one mechanically separating layer has gaps whose number and diameter are designed in such a way that the incoming air can pass through the at least one mechanically separating layer while particles are largely trapped therein. The at least one mechanically separating layer thus serves to ensure a high mechanical separation efficiency of fine dusts. As a result, it has a slightly higher flow resistance than the electret layer, of which there is at least one.

At least one electrically conductive layer is also arranged on the downstream side of the at least one mechanically separating layer. For example, it could be a metal mesh, such as stainless steel. Alternatively, it can be, for example, a layer comprising at least one activated carbon layer.

The at least one electret layer, the at least one mechanically separating layer and optionally the at least one electrically conductive layer can be stacked on top of one another and pressed and laminated or, for example, additionally joined at the cut edges linearly and in the surface pointwise by means of ultrasonic welding or thermal welding or glued to one another. This also applies, mutatis mutandis, to other layers and layers to be explained in more detail in the application.

In the context of the present application, a “layer” is understood to be a contiguous unit with a thickness running in the direction of flow. In this context, such a layer may consist of a single layer. Alternatively, however, it is also possible for such a layer to have several, i.e., at least two consecutive layers, wherein such layers differ from one another, for example in their material composition.

It is also conceivable, for example, that the at least one filter medium is inserted into a frame contained in the air filter unit. This can help to improve the stability of the structure. All frames for filter media known to those skilled in the art are suitable. Such a frame can be made of metal or plastic, for example. For example, the frame can be made of thermoplastics, thermosets, or elastomers. The frame is made of a thermoplastic material. For example, the frame is made of PA6, PA6.6, polypropylene, polyethylene, polystyrene, acrylonitrile butadiene styrene copolymer, polyethylene terephthalate, or polyether ether ketone. It goes without saying that the framework may contain additional excipients, such as binders, cross-linking agents, and additives. It is particularly useful that the frame is glass fiber reinforced. For example, the frame can be made of PA6.6 GF30. It also goes without saying that it is also conceivable that sealing elements are fitted between the filter medium and the frame.

It has proven to be advantageous for the layer that is at least electrically conductive to be in electrical contact with a counter-electrode of the ionization unit. It goes without saying that the electrical contacting of the at least one electrically conductive layer with a counter-electrode of the ionization unit is advantageously carried out via an electrically conductive, flat layer, for example a flat layer which has activated carbon or consists of activated carbon is suitable for this purpose. This electrical contact is particularly advantageous because it enables the filter medium to be reactivated with regard to the function of the electret layer. This in turn has the beneficial effect of significantly increasing the separation efficiency with regard to fine dust or other particles.

In the present context, “electrically contacted” refers to all constellations in which an electrical path runs between the electrically conductive layer and the counter-electrode.

The electrical contact can be realized, for example, by means of an electrical conductor that runs between the electrically conductive layer and the counter-electrode.

Alternatively or additionally, electrical contact may be achieved by electrically connecting the electrically conductive layer and the counter-electrode to the same electrical potential.

For example, it has proven to be useful if a first electrical potential is or can be applied to the air filter unit at the one or more corona discharge electrodes, and a second electrical potential, which is different from the first electrical potential, is or can be applied to the at least one counter-electrode and the at least one electrically conductive layer. Please refer to the previous sections for details of how the first and second electrical potentials, which differ from the first, are configured.

In the preferred case that a negative corona discharge is to take place at one or more of the corona discharge electrodes, a negative potential difference is or can be applied during operation of the air filter unit between the one or more corona discharge electrodes on the one hand and the at least one counter-electrode and the at least one electrically conductive layer on the other. As a result, particles with negative polarization are at least partially equipped in the externally supplied airflow, which are deposited in the at least one electret layer, whereby in turn a polarization effect can form between the at least one electret layer loaded with the particles with negative polarization and the at least one electrically conductive layer. Alternatively, however, it is also conceivable that the air filter unit is set up and operated in such a way that a positive corona discharge occurs at one or more of the corona discharge electrodes.

Furthermore, it has proven advantageous if the electrical contacting of the at least one electrically conductive layer with a counter-electrode of the ionization unit can be controlled in time in such a way that the at least one electrically conductive layer is electrically disconnected from the counter-electrode after a predetermined polarization time and is electrically reconnected to the counter-electrode after a predetermined depolarization time. Controllability can be achieved, for example, by at least one electrical switch. Electrical switches for time-controllable disconnecting and connecting are known per se to a person skilled in the art. For example, an electromechanical relay can be used for this purpose. Alternatively, the shifting can be done purely electrically, for example. For example, a bipolar transistor with an insulated gate electrode (IGBT) or a metal-oxide-semiconductor field-effect transistor (MOSFET) can be used for this purpose.

This means that the at least one electrically conductive layer is preferably only connected to the counter-potential for a predetermined polarization time. It goes without saying that this predetermined polarization time depends on the desired polarization value. This measure is based on the finding that after the polarization of the at least one electrically conductive layer, in particular if the at least one electrically conductive layer is a layer containing activated carbon, the separation performance of the filter medium decreases only slowly, so that electrical power can be saved by the time-controlled electrical separation of the at least one electrically conductive layer.

After a predetermined depolarization time has elapsed, the at least one electrically conductive layer can be reconnected to the counter-potential, i.e., to a counter-electrode of the ionization unit. The polarization and depolarization times depend on the application and the design of the air filter unit, for example the dimensions of the filter medium and the amount of air to be filtered.

The electrical connection and disconnection of the electrically conductive layer to or from the counter-electrode advantageously means a corresponding connection and disconnection in the electrical contact or in the electrical path.

The control of the electrical connection and disconnection, in particular of the at least one electrical switch, is advantageously carried out by means of a suitably designed control device.

Alternatively or additionally, it is possible to arrange at least one electrical resistor in the electrical contact, in particular in the electrical path. This results in a reduced flow of electrical charges to the electrically conductive layer. This means that a time control of the electrical contacting is no longer necessary, or at least can be reduced. The air filter unit is designed to be simple and cost-effective.

It has also proven to be advantageous if the at least one filter medium on the downstream side of the at least one electrically conductive layer also has a carrier layer. This serves to stabilize the filter medium. For example, it has proven advantageous when the carrier layer has polyester fibers, such as fibers made of polyethylene terephthalate. For example, the carrier layer can be a nonwoven made of spunbonded nonwoven fabric, whereby the nonwoven has polyester fibers, for example.

It is also conceivable, for example, that the carrier layer is a spunbonded nonwoven made of polymer fibers, wherein the fibers are made of two polymers, so-called “BiCo” fibers. These are known to the specialist, for example, under the Delta®-BiCo technology. BiCo fibers typically use a polymer material in the core of the fiber that is different from the polymer material of the fiber sheath. Typically, these BiCo fibers are produced as continuous filaments, which in turn can be used to make nonwovens. For example, it is conceivable that the fibers have a core made of polyethylene terephthalate and a sheath made of polybutylene terephthalate.

Spunbonded nonwovens are known to those skilled in the art. Typically, spunbonded nonwovens are obtained by stretching the polymer after extruding it into fine, continuous filaments, which are then deposited irregularly on a substrate. Preferably, the spunbonded nonwoven fabric used has a grammage of approximately a minimum of 25 g/m² to approximately a maximum of 100 g/m², more preferably the spunbonded nonwoven fabric used has a grammage of approximately a minimum of 45 g/m² to approximately a maximum of 75 g/m². More preferably, the spunbonded nonwoven fabric used has an air permeability (LD) of approximately a minimum of 3500 L/(m²s) to approximately a maximum of 10000 L/(m²s) at 200 Pa, more preferably the spunbonded nonwoven fabric used has an air permeability (LD) of approximately a minimum of 5500 L/(m²s) to approximately a maximum of 6500 L/(m²s) at 200 Pa. The air permeability can be determined according to DIN EN 9237:1995.

Furthermore, the spunbonded nonwoven fabric used has fibers with a thickness of approximately a minimum of 20 μm to approximately a maximum of 80 μm.

Of course, it is conceivable that the carrier layer contains additional excipients, such as binders, cross-linking agents, and additives. Examples of binders are acrylates and melamine formaldehyde. One example of an additive is polyurethane. For example, the carrier layer contains additional excipients in small percentages by weight, in particular, less than 2% by weight of the respective excipients are present in the carrier layer.

The carrier layer typically has a thickness of approximately a minimum of 80 μm to approximately a maximum of 2 mm, preferably the carrier layer has a thickness of 300 μm to approximately a maximum of 1 mm.

The determination of the thickness of such a layer is known to those skilled in the art and can be carried out, for example, according to DIN EN ISO 9073-02:1997.

Furthermore, it has proven advantageous if the filter medium has a cover nonwoven on the inflow side in front of the at least one electret layer. This cover nonwoven is advantageous as a light, open cover nonwoven with a grammage of less than about 50 g/m², preferably about 16 g/m², and serves to trap the largest dust particles and thus reduce the load on the following layers without significantly increasing the flow resistance. It also prevents fibers from the following layer from coming loose. For example, the cover nonwoven can be made of polypropylene fibers with a grammage of less than about 50 g/m², preferably about 16 g/m².

Regarding the optional excipients contained in the cover nonwoven, such as binders, cross-linking agents, and additives, please refer to the information given above in connection with the carrier layer.

In addition, it has proven useful for the at least one electret layer to have at least two layers. This means that the electret layer can preferably have either two layers or, alternatively, three or more layers. Preferably, the at least two layers have fibers and the diameter of the fibers in the layers decreases in the direction of flow. Alternatively, it is also conceivable that the diameter of the fibers in the layers remains approximately the same. The at least one electret layer effectively protects the at least one mechanically separating layer from becoming clogged with dust particles.

In principle, all nonwoven, woven, knitted, or crocheted fabrics that can be electrostatically charged or have an electrostatic charge can be used for the at least two layers of the electret layer. The respective layers of the electret layer may, for example, comprise melt-blown or spun-bonded continuous polymer fibers, which are processed, for example, in the form of a nonwoven. Meltblown fibers can be obtained by forcing molten polymer through an extruder with small capillaries and blowing the fibers emerging from the capillaries with hot air in a direction, stretching them and then thermally bonding them. An example of such a layer of the electret layer is melt-blown polypropylene nonwoven. Furthermore, it is conceivable to use melt-blown or spun-bonded fibers made of polyester, such as polyethylene terephthalate, polycarbonate, or polyamide. Alternatively, it is also conceivable to use staple fibers with an electrical charge or electrostatically charged staple fibers. For example, it is conceivable to use staple fibers made of polyester, such as polyethylene terephthalate, or of polyamide or polypropylene.

It is conceivable that the fibers comprise one polymer material, but it is also conceivable that the fibers comprise two or more polymer materials. An example of polymer fibers that are made of two polymers are the so-called “BiCo” fibers, which, as mentioned above, are known to those skilled in the art, for example, under the Delta®-BiCo technology.

With regard to the optional excipients contained in the at least one electret layer, reference is made to the above information in connection with the carrier layer.

It has proved advantageous if the electret layer has two layers, the first, wherein the upstream layer is made of a nonwoven containing polypropylene fibers and polycarbonate fibers, more preferably of a nonwoven containing polypropylene fibers and polycarbonate fibers with a grammage of approximately a minimum of 20 g/m² and approximately a maximum of 40 g/m², more preferably of a nonwoven comprising polypropylene fibers and polycarbonate fibers having a grammage of approximately 30 g/m², and the second layer, aligned downstream thereof, of a nonwoven comprising poly polypropylene fibers, more preferably a nonwoven comprising polypropylene fibers and having a weight of approximately a minimum of 10 g/m² and approximately a maximum of 30 g/m², and particularly preferably a nonwoven comprising polypropylene fibers and having a weight of approximately 20 g/m². This arrangement can effectively protect the subsequent mechanically separating layer from large particles.

Alternatively, it has proven advantageous for the electret layer to have three layers, each consisting of a nonwoven made of melt-blown thermoplastic polymer fibers, in particular polypropylene fibers. For example, the first layer, i.e., the layer facing upstream, consists of a nonwoven with a grammage of approximately 20 g/m², the second layer, i.e., the layer facing downstream, consists of a nonwoven with a grammage of approximately 15 g/m², and the third layer, i.e., the layer facing downstream, consists of a nonwoven with a grammage of approximately 15 g/m².

The thickness of the at least one electret layer is typically from approximately a minimum of 300 μm to approximately a maximum of 5 mm. In addition, the at least one electret layer is designed with gaps. It goes without saying that the gaps are typically designed as open gaps in order to ensure permeability for the air to be cleaned, even though it cannot be ruled out that the at least one electret layer also includes closed gaps for production reasons. Preferably, the at least one electret layer further has an air permeability (LD) of approximately a minimum of 300 L/(m²s) to approximately a maximum of 1500 L/(m²s) at 200 Pa.

It is conceivable that the diameter gaps are constantly distributed over the entire thickness of the at least one electret layer. However, it has proven to be particularly advantageous that the gaps on the side facing the oncoming airflow initially have a slightly larger diameter and that further in the direction of the side facing away from the oncoming airflow, they have a slightly smaller diameter. This can be achieved by pressing the fibers more closely together on the side facing away from the incoming airflow than on the side facing the airflow. Furthermore, it has proven to be particularly advantageous that the diameters of the fibers are initially slightly larger on the side facing the oncoming airflow and slightly smaller further in the direction of the side facing away from the oncoming airflow. For example, the diameters of the fibers in a first layer facing the airflow can be approximately a minimum of 8 μm to approximately a maximum of 50 μm and the diameters of the fibers in a second layer arranged after the first layer can be approximately a minimum of 1 μm to a approximately a maximum of 10 μm. This can be used to ensure that the largest dust particles are separated first, followed by the smaller dust particles further inside the layers. This maximizes the lifespan and filtration performance of the filter medium.

It is expedient to use an electret layer, as described above, which in turn can have one or more layers. However, it is also conceivable, for example, to use two or more layers of the at least one electret layer on top of each other. These two or more layers of the at least one electret layer may in turn comprise one or more layers. However, an electret layer is preferred.

In principle, the at least one mechanically separating layer can continue to have one or more layers. It has proven to be particularly effective when the at least one mechanically separating layer has a coating, as this leads to a particularly good result in terms of both the separation efficiency and the flow resistance. In principle, all nonwovens, fabrics, knitted, or crocheted materials that enable the mechanical separation of particles can be used for one or more layers of the at least one mechanically separating layer.

However, it has proven to be particularly advantageous that the at least one mechanically separating layer has nanofibers, wherein the diameter of the nanofibers is approximately a minimum of 10 nm to approximately a maximum of 800 nm, preferably the diameter of the nanofibers being approximately a minimum of 90 nm to approximately a maximum of 500 nm. In particular, it has proven to be advantageous when the diameter of the nanofibers is approximately a minimum of 90 nm to approximately a maximum of 120 nm.

This means that, in the event that the at least one mechanically separating layer has a layer, this layer preferably has nanofibers. In the event that the at least one mechanically separating layer has several layers, it means that at least one of these layers preferably has nanofibers.

In addition, it has proven to be advantageous if the nanofibers are obtained by electrospinning a polymer material. The process of electrospinning as such is known to those skilled in the art. Typically, a polymer solution is dosed onto an electrode, where it is accelerated away from the electrode by an electric field. This causes continuous filaments to form, which are deposited on a counter-electrode as a nonwoven.

Furthermore, it is preferred that the one or more layers of the mechanically separating layer each have a grammage of approximately a minimum of 0.5 g/m² to approximately a maximum of 2 g/m², preferably approximately 1 g/m².

Preferably, the one or more layers of the mechanically separating layer are each made of a nonwoven fabric, which is made of polyamide fibers, in particular fibers of PA6.6, of polypropylene fibers, of polyester fibers, such as, for example, fibers of polyethylene terephthalate, or of polyvinyl alcohol. In this case, it is conceivable that different layers stacked on top of each other are made of the same material. It is also conceivable that the at least one mechanically separating layer has two or more layers of different nonwoven materials, such as a layer of polypropylene nonwoven and another layer of polyamide nonwoven.

Regarding the optional excipients contained in the at least one mechanically separating layer, the same applies as stated above in connection with the carrier layer.

The at least one mechanically separating layer typically has a thickness of approximately a minimum of 1 μm to approximately a maximum of 0.5 mm. In addition, the at least one mechanically separating layer is designed with gaps. It goes without saying that the gaps are typically designed as open gaps in order to ensure permeability for the air to be cleaned, even if it cannot be ruled out that the at least one mechanically separating layer also includes closed gaps for production-related reasons.

For example, the at least one mechanical layer, in the event that it consists of a layer of polypropylene nonwoven and a further layer of polyamide nonwoven, preferably has an air permeability (LD) of approximately a minimum of 200 L/(m²s) to approximately a maximum of 600 L/(m²s) at 200 Pa.

It is conceivable that the diameters of the gaps are uniformly distributed throughout the entire thickness of the at least one mechanically separating layer. However, it has proven to be particularly advantageous that the gaps on the side facing the oncoming airflow initially have a slightly larger diameter and that further in the direction of the side facing away from the oncoming airflow, they have a slightly smaller diameter. This is advantageous, for example, if the at least one mechanically separating layer has a total thickness of approximately 0.5 mm and contains a layer of nanofibers, which in turn has been applied to a layer of a polypropylene or polyamide nonwoven. This helps to maximize the lifespan and filtration performance of the filter medium.

As described above, it is expedient to use a mechanically separating layer, which in turn can have one or more layers. However, it is also conceivable, for example, to use two or more layers of the at least one mechanically separating layer on top of each other. These two or more layers of the at least one mechanically separating layer may in turn have one or more layers. However, it is particularly advantageous to use a mechanically separating layer.

It has also proven advantageous that the at least one electrically conductive layer is also a gas adsorption layer. This means that the at least one electrically conductive layer contains or consists of a material that enables gas adsorption, such as activated carbon.

It has also proven advantageous that the at least one electrically conductive layer has at least two layers, wherein at least one of the layers comprises activated carbon. It is also conceivable that the at least one electrically conductive layer has two or more layers, which in turn each have activated carbon.

Alternatively, it has proven advantageous if the at least one electrically conductive layer has at least two layers, wherein at least one of the layers is made of activated carbon. It is also conceivable that the at least one electrically conductive layer has two or more layers, which in turn each consist of activated carbon.

For example, such a layer consisting of or comprising activated carbon may consist of or comprise granular activated carbon. Alternatively, such a layer, which consists of or contains activated carbon, may also consist of or contain fibrous activated carbon. Furthermore, such a layer, which consists of activated carbon or contains activated carbon, may consist of or contain so-called spherical carbon. Alternatively, such a layer, consisting of or comprising activated carbon, may consist of or comprise both granular and fibrous activated carbon. In addition, such a layer consisting of or comprising activated carbon may alternatively consist of or comprise both spherical and fibrous activated carbon.

Such a layer consisting of or comprising activated carbon further preferably has a grammage of approximately a minimum of 100 g/m² to approximately a maximum of 750 g/m², more preferably such a layer consisting of or comprising activated carbon layer has a grammage of approximately a minimum of 300 g/m² to approximately a maximum of 400 g/m², it being particularly preferred that the grammage of such a layer consisting of activated carbon or having activated carbon is approximately 350 g/m².

Furthermore, it has proven to be advantageous if the at least one electrically conductive layer has at least two layers, wherein at least one of the two layers has an ion exchanger. Alternatively, it has proven advantageous if the at least one electrically conductive layer has at least two layers, wherein at least one of the two layers has an ion exchanger and activated carbon. It is of course also conceivable that the at least one electrically conductive layer contains two layers, with one of the two layers containing activated carbon and the other of the two layers containing an ion exchanger. For example, it is conceivable that the at least one electrically conductive layer contains a layer comprising a granulate made from a mixture of activated carbon and an ion exchanger. Alternatively, it is also conceivable that the at least one electrically conductive layer contains a layer comprising a fiber mixture of activated carbon fibers and ion exchanger fibers.

For example, it is conceivable that the at least one electrically conductive layer contains two layers, wherein one of the two layers contains an activated carbon granulate and has a grammage of approximately a minimum of 100 g/m² to approximately a maximum of 600 g/m² and the other of the two layers contains an ion exchanger granulate and has a grammage of approximately a minimum of 100 g/m² to approximately a maximum of 390 g/m². In particular, it is preferred that the at least one electrically conductive layer contains two layers, wherein one of the two layers contains an activated carbon granulate and has a grammage of approximately 300 g/m² and the other of the two layers contains an ion exchanger granulate and has a grammage of approximately 220 g/m².

Alternatively, it is conceivable, for example, that at least one electrically conductive layer in the direction of flow initially contains a first layer comprising granular activated carbon with a grammage of approximately 160 g/m², followed by a second layer containing fibrous activated carbon with a grammage of approximately 160 g/m² and, adjacent to this, a cation exchanger layer with a grammage of approximately 250 g/m².

The ion exchanger can contain both a cation and an anion exchanger or a mixed bed ion exchanger. However, it is also conceivable that the ion exchanger contains only an anion exchanger or only a cation exchanger. Preferably, the ion exchanger contains a cation exchanger.

Anion and cation exchangers as such are known to those skilled in the art. For example, anion exchange resins may be materials with secondary or tertiary amine or quaternary ammonium compounds. Suitable anion exchangers are based, for example, on poly(styrene-co-divinylbenzene) beads functionalized with quaternary ammonium groups.

For example, a cation exchanger may be a material with sulfonic acid groups or carboxylic acid groups. For example, such cation exchangers are a plastic resin, for example based on polystyrene, with sulfonic acid groups firmly bonded to the resin. Suitable cation exchangers are based, for example, on poly(styrene-co-divinylbenzene) beads functionalized with sulfonic acid groups.

Furthermore, it has proven advantageous when the at least one electrically conductive layer has at least two layers, with one of the two layers comprising activated carbon and one of the two layers containing activated carbon and ion exchangers.

It is also useful for the activated carbon to be fixed in layers comprising activated carbon, for the ion exchanger to be fixed in layers comprising an ion exchanger, or for the activated carbon and the ion exchanger to be fixed in layers comprising both activated carbon and ion exchanger, with an adhesive.

All common adhesive systems can be used for bonding.

For example, a physically hardening adhesive system can be selected from the group of polyamide resins, saturated polyesters, ethylene-vinyl acetate copolymers, polyolefins, styrene-butadiene-styrene block copolymers, styrene-isoprene-styrene block copolymers and polyimides, or a chemically curing adhesive system selected from the group of epoxy resins, polyurethanes, phenol-formaldehyde resins, silicones, and cyanoacrylates. It has been shown to be more advantageous to use an adhesive system selected from the group of polyolefins or an adhesive system from the group of epoxy resins or polyurethanes. In particular, the use of a physically curing adhesive system made of polypropylene has proven to be particularly advantageous. Typically, such systems are available as hot-melt polypropylene.

A layer comprising an ion exchanger further preferably has a basis weight of approximately a minimum of 100 g/m² and approximately a maximum of 390 g/m², more preferably such a layer comprising an ion exchanger has a basis weight of approximately 220 g/m².

The at least one electrically conductive layer preferably has a thickness of approximately a minimum of 500 μm to approximately a maximum of 5 mm, more preferably the at least one electrically conductive layer has a thickness of approximately a minimum of 800 μm to approximately a maximum of 3 mm. In particular, the at least one electrically conductive layer has a thickness of approximately 2 mm.

It is advisable to use an electrically conductive layer, in particular a layer containing activated carbon, as described above, which in turn may comprise one or more layers. However, it is also conceivable, for example, to use two or more layers of the at least one electrically conductive layer on top of each other. These two or more layers of the at least one electrically conductive layer may in turn have one or more layers. However, it is particularly advantageous to use an electrically conductive layer.

Furthermore, it has proven advantageous to arrange at least one intermediate layer between the at least one mechanically separating layer and the at least one electrically conductive layer. Among other things, this serves to mechanically stabilize the at least one mechanically separating layer.

The intermediate layer, of which there is at least one, is advantageously designed as a light, open nonwoven with a grammage of less than approximately 50 g/m², more particularly approximately 16 g/m². For example, the nonwoven can be made of polypropylene fibers with a grammage of less than approximately 50 g/m², preferably approximately 16 g/m².

Regarding the optional excipients contained in the at least one intermediate layer, the same applies as stated above in relation to the carrier layer.

In addition, it has proven to be advantageous if the filter medium is pleated, i.e., if the filter medium is folded. This allows a larger filter area to be provided without significantly increasing the flow resistance.

Furthermore, the present invention is based on the general idea of providing an air filter unit as described above for use in a motor vehicle. In particular, the proposed air filter unit is suitable for use in a vehicle air conditioning unit, a vehicle ventilation system, a vehicle heating system or a combined heating, ventilation, and air conditioning (HVAC) system).

Further important features and advantages of the invention are apparent from the sub-claims, from the drawings, and from the associated description of the figures with reference to the drawings.

It is understood that the features mentioned above and those to be explained below can be used not only in the combination indicated in each case, but also in other combinations or on their own, without departing from the scope of the present invention.

### BRIEF DESCRIPTION OF THE DRAWINGS

It shows, schematically in each case:

FIG. 1 shows a simplified perspective view of a preferred air filter unit comprising an ionization unit and a filter medium,

FIG. 2 shows a simplified representation of a filter medium,

FIG. 3 shows a simplified representation of a filter medium with several layers according to a preferred embodiment,

FIG. 4 shows a graphical representation of the separation efficiency for fine dust of a filter medium in new condition compared to the aged filter medium, as well as the respective effect of a proposed combination of the filter medium with an ionization unit and an additional polarization effect.

### DETAILED DESCRIPTION

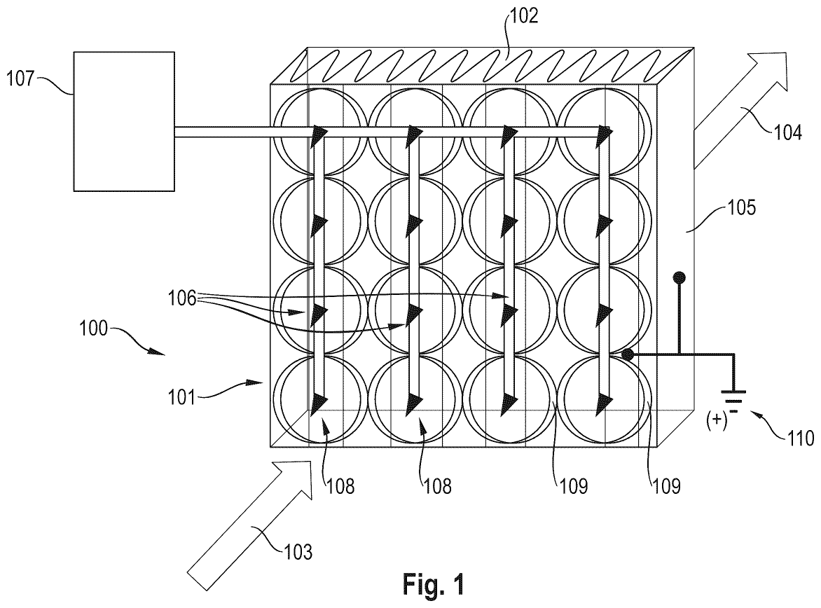

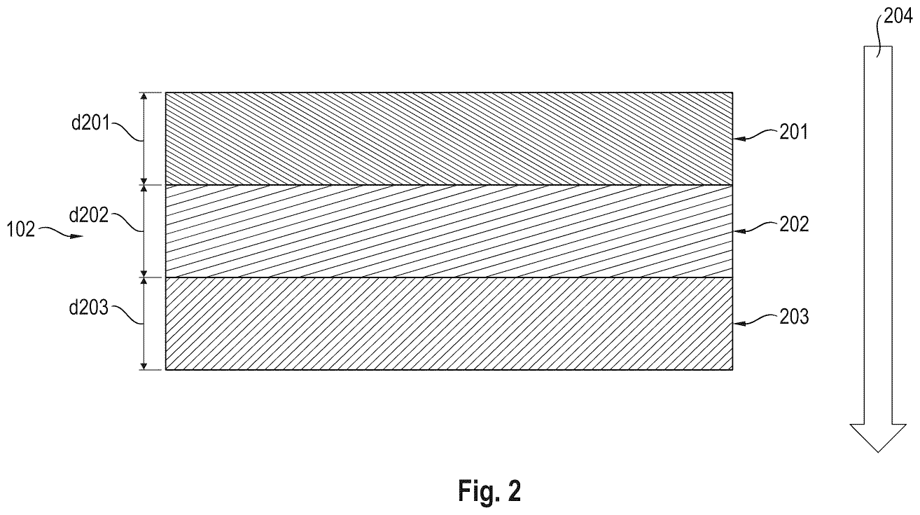

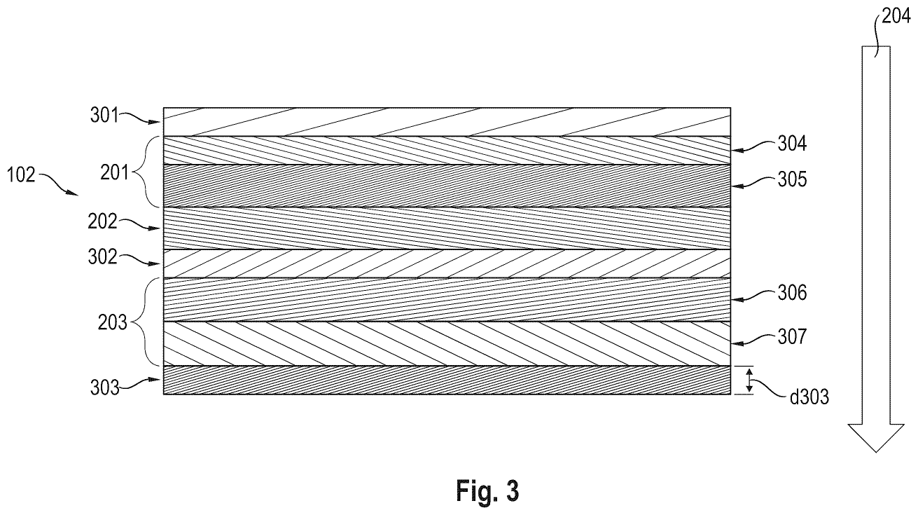

FIG. 1 shows, in a highly simplified perspective view, a preferred air filter unit 100 that is preferably installed in a housing 105 of an air conditioning unit of a vehicle that is not shown. FIG. 1 also shows the airflow of the air supplied from the outside in the direction of air inflow 103 and the air outflow 104 after passing through the ionization unit 101 and the filter medium 102. It goes without saying that the air supplied from the outside is outside air, which, especially in urban environments, carries fine dust that should be separated with the help of the air filter unit 100. The air cleaned in this way is then supplied to the passenger compartment, which is not shown in FIG. 1. The airflow from the external air supply passes completely through the air filter unit. Gas molecules contained in the airflow are at least partially ionized by the ionization unit 101, which is indicated in FIG. 1 in a highly simplified representation. When the ionized gas molecules attach to the surfaces of particles in the air, these in turn become electrically charged. This can achieve an increased particle separation rate in the filter medium 102. The structure of the filter medium 102 is described in more detail in FIGS. 2 and 3. The ionization unit 101 shown in FIG. 1 has several electrodes 108 that are located in a single plane, serve to generate a corona discharge and are designed as so-called corona discharge electrodes, for example made of stainless steel. These are indicated by small triangles in FIG. 1. These corona discharge electrodes 108 are connected to a high-voltage source 107 in an electrically conductive manner via an electrical conductor 106. In addition, the ionization unit 101 has counter-electrodes 109, which, in the embodiment shown in FIG. 1, are each formed as hollow cylindrical counter-electrode bodies through which air can flow. The filter medium 102 is shown schematically in FIG. 1 in a pleated configuration, but can alternatively also be flat. The electrically conductive layer of the filter medium 102, which is not illustrated in FIG. 1, can optionally be electrically contacted to a counter-electrode via a further electrical conductor 110. When the air filter unit 100 is in operation, the high-voltage source 107 can now be used to apply an initial electrical potential to the corona discharge electrodes 108, while a second electrical potential, which differs from the first electrical potential, is applied to the counter-electrodes 109 and optionally to the electrically conductive layer of the filter medium 102.

FIG. 2 shows a basic form of the filter medium 102, in the direction of flow 204 of the air comprising an electret layer 201 with a thickness d₂₀₁, a mechanically separating layer 202 with a thickness d₂₀₂ and an electrically conductive layer 203 with a thickness d₂₀₃.

FIG. 3 illustrates a preferred embodiment of a filter medium 102. This initially has a cover nonwoven 301 in the direction of air 204. Subsequently, in the direction of flow, there is an electret layer 201 comprising two layers 304 and 305. This is followed by a mechanically separating layer 202. This is separated from the following electrically conductive layer 203 by an intermediate layer 302, which has two layers 306 and 307. This is followed by a carrier layer 303 with a thickness of d₃₀₃.

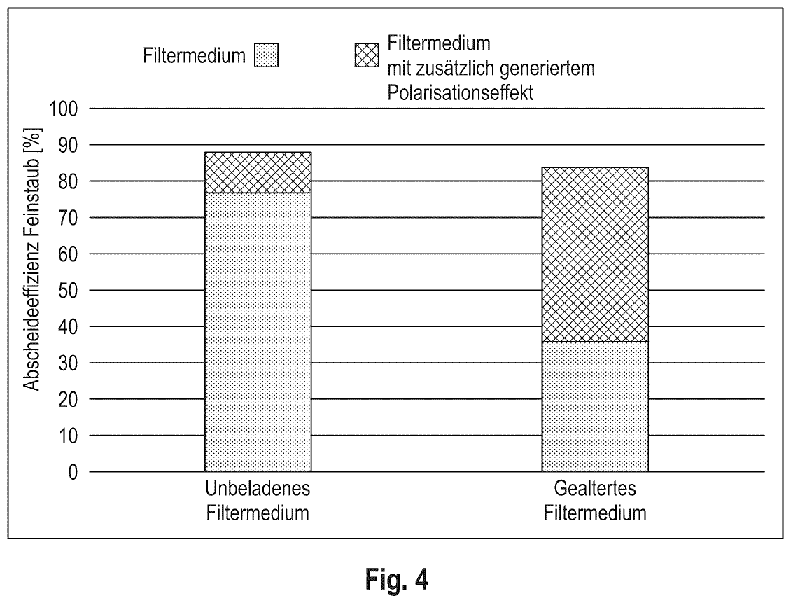

FIG. 4 illustrates the separation efficiency for fine dust of the filter medium illustrated in FIG. 3 in new condition compared to the aged filter medium, as well as the respective effect of a proposed combination of the filter medium with an ionization unit and an additional polarization effect.

The additional polarization effect is obtained due to the advantageous electrical contact of the at least one electrically conductive layer with a counter-electrode of the ionization unit. It can be clearly seen that in the case of the unloaded filter medium (new condition), the separation efficiency for fine dust is initially high and the increase in separation achieved by an additional polarization effect is initially relatively low. However, as the filter medium ages, the separation efficiency of the filter medium as such decreases. However, an additional polarization effect can be used to maintain approximately the same separation efficiency as an unloaded filter medium. To obtain an aged filter medium, it is conceivable, on the one hand, to initially use the filter medium in real driving conditions. Alternatively, the filter medium can be artificially aged, as shown in FIG. 4, to simulate driving. This is done by exposing a filter medium to isopropanol vapor in a closed chamber for a period of 48 hours.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. An air filter unit, comprising:
at least one ionization unit including at least one corona discharge electrode, at least one counter-electrode, and at least one voltage source; and
at least one filter medium arranged downstream of the at least one ionization unit, the at least one filter medium including at least one electret layer, at least one mechanically separating layer, and at least one electrically conductive layer adjoining the at least one mechanically separating layer; and
wherein, in an airflow direction extending from an inflow side toward an outflow side, the at least one electret layer, the at least one mechanically separating layer, and the at least one electrically conductive layer are arranged one after another in this order.

2. The air filter unit according to claim 1, wherein the at least one electrically conductive layer is in electrical contact with the at least one counter-electrode of the at least one ionization unit.

3. The air filter unit according to claim 1, wherein:
the at least one electrically conductive layer is selectively in electrical contact with the at least one counter-electrode of the at least one ionization unit; and
the electrical contact of the at least one electrically conductive layer with the at least one counter-electrode is controllable in time such that the at least one electrically conductive layer is electrically disconnected from the at least one counter-electrode after a predetermined polarization time has elapsed and is electrically reconnected to the at least one counter-electrode after a predetermined depolarization time has elapsed.

4. The air filter unit according to claim 2, further comprising at least one electrical resistor arranged in the electrical contact between the at least one electrically conductive layer and the at least one counter-electrode.

5. The air filter unit according to claim 1, wherein the at least one filter medium further includes a carrier layer disposed on a downstream side of the at least one electrically conductive layer.

6. The air filter unit according to claim 1, wherein the at least one filter medium further includes a cover nonwoven disposed on the inflow side in front of the at least one electret layer.

7. The air filter unit according to claim 1, wherein the at least one electret layer has at least two layers.

8. The air filter unit according to claim 1, wherein the at least one mechanically separating layer includes a plurality of nanofibers having a diameter of approximately 10 nm to 800 nm.

9. The air filter unit according to claim 1, wherein the at least one electrically conductive layer is also a gas adsorption layer.

10. The air filter unit according to claim 1, wherein the at least one electrically conductive layer includes at least two layers, and wherein at least one of the at least two layers includes activated carbon.

11. The air filter unit according to claim 1, wherein the at least one electrically conductive layer includes at least two layers, and wherein at least one of the at least two layers includes an ion exchanger.

12. The air filter unit according to claim 1, further comprising at least one intermediate layer arranged between the at least one mechanically separating layer and the at least one electrically conductive layer.

13. The air filter unit according to claim 1, wherein the at least one filter medium is pleated.

14. A use of an air filter unit according to claim 1 in a motor vehicle.

15. The air filter unit according to claim 7, wherein the at least two layers of the at least one electret layer includes at least two fiber layers having a plurality of fibers.

16. The air filter unit according to claim 15, wherein a diameter of the plurality of fibers decreases in the airflow direction.

17. The air filter unit according to claim 8, wherein the diameter of the plurality of nanofibers is approximately 90 nm to 500 nm.

18. The air filter unit according to claim 11, wherein the at least one of the at least two layers further includes activated carbon.

19. The air filter unit according to claim 1, wherein the at least one electrically conductive layer includes at least two layers, and wherein at least one layer of the at least two layers includes a fiber mixture of activated carbon fibers and ion exchanger fibers.

20. An air filter unit, comprising:
an ionization unit including:
at least one counter-electrode;
at least one corona discharge electrode arranged downstream of the at least one counter-electrode relative to an airflow direction extending from an inflow side toward an outflow side; and
at least one voltage source;
a filter medium arranged downstream of the ionization unit relative to the airflow direction, the at least one filter medium including:
an electret layer;
an electrically conductive layer; and
a mechanically separating layer disposed between the electret layer and the electrically conductive layer in the airflow direction;
wherein the at least one corona discharge electrode is an electrode rod; and
wherein the at least one counter-electrode is a grid structure through which air is flowable and is selectively in electrical contact with the electrically conductive layer via an electrical switch.
